(19) United States
(12) Patent Application Publication
(10) Pub. No.: US 2013/0216859 A1
(43) Pub. Date: Aug. 22, 2013

(54) Multilayer assembly as reflector

(71) Applicants: Timo Kuhlmann, Leichlingen (DE); Michael Wagner, Moers (DE); Oser Rafael, Krefeld (DE); Terry G. Davis, Kimball, MI (US); Ignacio Osio, Gibsonia, PA (US)

(72) Inventors: Timo Kuhlmann, Leichlingen (DE); Michael Wagner, Moers (DE); Oser Rafael, Krefeld (DE); Terry G. Davis, Kimball, MI (US); Ignacio Osio, Gibsonia, PA (US)

(73) Assignees: Bayer MaterialScience AG, Leverkusen (DE); Bayer MaterialScience LLC, Pittsburg, PA (US)

(21) Appl. No.: 13/400,159

(22) Filed: Feb. 20, 2012

(51) Int. Cl. B32B 15/04

(52) U.S. Cl. 428/623

(57) ABSTRACT

The present invention relates to a multilayer assembly for use as a mirror/reflector in the sector of CPV (concentrating photovoltaics) and CSP (concentrating solar power). The multilayer assembly contains a substrate layer, a barrier layer, a reflective metallic layer, an oxidic layer and one other layer, which can be a plasma polymer layer or a highly refractive metal oxide layer.

The present invention relates to a multilayer assembly for use as a mirror/reflector in the sector of CPV (concentrating photovoltaics) and CSP (concentrating solar power). The multilayer assembly contains a substrate layer, a barrier layer, a reflective metallic layer, an oxidic layer and one other layer, which can be a plasma polymer layer or a highly refractive metal oxide layer.

Silver mirrors for use in the CPV and CSP sector are already known.

WO 2000007818 describes silver mirrors based on a polymer substrate with a silver layer applied directly to it, said silver layer in turn having a protective polymer layer directly superimposed on it and firmly bonded thereto. A UV-absorbing polymer film is applied to this polymer layer.

U.S. Pat. No. 6,078,425 describes multilayer mirrors containing reflective layers of aluminium and silver, an adhesive layer of nickel and/or chromium alloys or nitrides being deposited on the surface of the aluminium. The silver layer is protected by a layer of nickel and/or chromium alloys or nitrides and one or more layers of metal oxides.

According to Society of Vacuum Coaters (2009), 52nd, 473-477, based on the known systems built up of a metallic layer (Al or Cu), a reflective silver layer and either a transparent protective layer of aluminium oxide or a silicon nitride layer with SiO₂ and tantalum oxide layers applied thereto, the complex protective layer system is replaced in order to effect mass production in short-cycle metallization plants. It is reported that the layer assemblies produced still have adequate reflectivity and weathering properties.

Society of Vacuum Coaters (2009), 52nd, 473-477, hence discloses special multilayer assemblies with increased reflectivity and weather resistance. Layer assemblies are described which have a plastic substrate, a metallic layer, a silver reflector applied thereto and a plasma siloxane top coat. However, the assembly described does not meet the requisite demands.

Concentrating Photovoltaic Conference 7 (CPV 7), Las Vegas, April 2011, declared the need to provide highly reflective silver mirrors of long durability for CPV applications. In this context various possible solutions are put forward in general form, inter alia, a system of the following general structure was put forward: substrate, metal, silver reflector, metal oxide, HMDSO.

in SVC/Society of Vacuum Coaters 2009, Optics O21, plasma coating is described as a simple method of producing reflective, corrosion-resistant, metallic multilayer systems, and experiments are carried out. It is described that, using this method, no aluminium oxide protective layers have so far been used in the above-described short-cycle coatings.

However, the property profile of the aforementioned systems is not adequate for the use of reflectors in the CPV and CSP sector, especially as regards obtaining a high reflectivity during their life when used outdoors. In particular, the adverse effect on reflectivity caused by increased corrosion due to weathering has still not been satisfactorily resolved for commercial use. Furthermore, it should be possible to produce these multilayer systems simply and cost-effectively in large piece numbers.

The object of the present invention is therefore to provide a multilayer system whose reflectivity is constantly high over the life cycle, it being possible to produce such multilayer bodies by a simple and cost-effective process. Furthermore, the multilayer system should have a high dimensional stability, a low cracking tendency and a low surface roughness, thereby satisfying the requirements of DIN EN 62108 in respect of stability to climate change (Chapters 10.6, 10.7 and 10.8).

The object was achieved by a multi layer assembly containing five layers:

layer A: a substrate layer selected from a thermoplastic, metal and glass;

layer B: a barrier layer selected from titanium and the precious metal group, preferred precious metals being gold, palladium, platinum, vanadium and tantalum;

layer C: a reflective metallic layer, preferably of silver or silver alloys, the silver alloy containing less than 10 wt. % of gold, platinum, palladium and/or titanium, and aluminium;

layer D: an oxidic layer selected from aluminium oxide (AlOₓ), titanium dioxide, SiO₂, Ta₂O₅, ZrO₂, Nb₂O₅ and HfO;

layer E:

a) a plasma polymer layer (anticorrosive layer) deposited from siloxane precursors, preferred examples being hexamethyldisiloxane (HMDSO), octamethylcyclotetrasiloxane (ONICTS), octamethyltrisiloxane (ON/ITS), tetraethylorthosilane (TEOS) and tetramethyldisiloxane (TMDSO), decamethylcyclopentasiloxane (DMDMS), hexamethylcyclotrisiloxane (HMCTS), trimethoxymethylsilane (TMOMS) and tetramethylcyclotetrasiloxane (TMCTS); HMDSO is particularly preferred; alternatively, in the case where layer D consists of aluminium oxide or SiO₂, layer E can be
b) a highly refractive metal oxide layer, the metal oxides being selected from titanium dioxide, SiO₂, Ta₂O₅, ZrO₂, Nb₂O₅ and HfO or SiO₂, and another layer as defined in layer E (a), i.e. a plasma polymer layer, can optionally be applied.

The Examples show that this multilayer assembly has the required property profile of a high dimensional stability, a low cracking tendency and a low surface roughness, thereby satisfying the requirements of DIN EN 62108 in respect of stability to climate change (Chapters 10.6, 10.7 and 10.8).

### Layer A:

Layer A is selected from a thermoplastic, metal and glass.

Preferred thermoplastics for the substrate layer are polycarbonate, polystyrene, styrene copolymers, aromatic polyesters such as polyethylene terephthalate (PET), PET/cyclohexanedimethanol copolymer (PETG), polyethylene naphthalate (PEN) and polybutylene terephthalate (PBT), cyclic polyolefin, poly- or copolyacrylates and poly- or copolymethacrylates, e.g. poly- or copolymethyl methacrylates (such as PMMA), copolymers with styrene, e.g. transparent polystyrene/acrylonitrile (PSAN), thermoplastic polyurethanes, polymers based on cyclic olefins (e.g. TOPAS®, a commercial product from Ticona), and polycarbonate blends with oletinic copolymers or graft polymers, e.g. styrene/acrylonitrile copolymers. Polycarbonate, PET or PETG is particularly preferred. In particular, the substrate layer consists of polycarbonate.

In terms of the present invention, polycarbonates are homopolycarbonates, copolycarbonates and polyestercarbonates, e.g. those in EP-A 1,657,281.

The aromatic polycarbonates are prepared e.g. by reacting diphenols with carbonyl halides, preferably phosgene, and/or with aromatic dicarboxylic acid dihalides, preferably benzenedicarboxylic acid dihalides, by the phase interface process, optionally using chain terminators, e.g. monophenols, and optionally using trifunctional or more than trifunctional branching agents, e.g. triphenols or tetra-phenols. They can also be prepared by reacting diphenols with e.g. diphenyl carbonate in a melt polymerization process.

Diphenols for preparing the aromatic polycarbonates and/or aromatic polyester-carbonates are preferably those of formula (I):

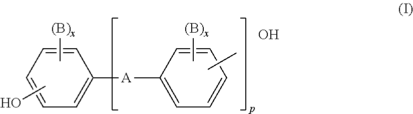

where
A is a single bond. C₁ to C₅-alkylene, C₂- to C₅-alkylidene, C₅- or C₆-cyclo-alkylidene, —O—, —SO—, C₆- to C₁₂-arylene to which other aromatic rings optionally containing heteroatoms can be fused, or a radical of formula (II) or (III):

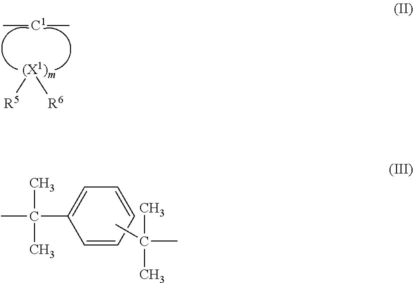

B are in each case C₁- to C₁₂-alkyl, preferably methyl, or halogen, preferably chlorine and/or bromine,
x are in each case, independently of one another, 0, 1 or 2.
p is 1 or 0,
R⁵ and R⁶ can be individually chosen for each X¹ and independently of one another are hydrogen or C₁- to C₆-alkyl, preferably hydrogen, methyl or ethyl,
X¹ is carbon and
m is an integer from 4 to 7, preferably 4 or 5,
with the proviso that R⁵ and R⁶ are simultaneously alkyl on at least one X¹ atom.

Examples of diphenols suitable for preparing the polycarbonates are hydroquinone, resorcinol, dihydroxybiphenyls, bis(hydroxyphenyl)alkanes, bis(hydroxyphenyl)-cycloalkanes, bis(hydroxyphenyl) sulfides, bis(hydroxyphenyl)ethers, bis-(hydroxyphenyl)ketones, bis(hydroxyphenyl)sulfones, bis(hydroxyphenyl) sulfoxides, alpha,alpha′-bis(hydroxyphenyl)diisopropylbenzenes, phthalimidines derived from isatin derivatives or phenolphthalein derivatives, and their ring-alkylated and ring-halogenated compounds.

Preferred diphenols are 4,4′-dihydroxybiphenyl, 2,2-bis(4-hydroxyphenyl)propane, 2,4-bis(4-hydroxyphenyl)-2-methylbutane, 1,1-bis(4-hydroxyphenyl)-p-diisopropyl-benzene, 2,2-bis(3-methyl-4-hydroxyphenyl)propane, 2,2-bis(3-chloro-4-hydroxy-phenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 1,1-bis(3,5-dimethyl-4-hydroxy-phenyl)-p-diisopropylbenzene, 2,2-bis(3,5-dichloro-4-hydroxyphenyl)propane, 2,2-bis(3,5-dibromo-4-hydroxyphenyl)propane, 1,1-bis(4-hydroxyphenyl)-3,3,5-trimethylcyclohexane and 2-hydrocarbyl-3,3-bis(4-hydroxyaryl)phthalimidines, as well as the reaction product of N-phenylisatin and phenol.

Particularly preferred diphenols are 2,2-bis(4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, 1,1-bis(4-hydroxyphenyl)cyclo-hexane and 1,1-bis(4-hydroxyphenyl)-3,3,5-trimethylcyclohexane.

In the case of the homopolycarbonates, only one diphenol is used; in the case of the copolycarbonates, several diphenols are used. Examples of suitable carbonic acid derivatives are phosgene and diphenyl carbonate.

Suitable chain terminators which can be used in the preparation of the polycarbonates are monophenols and monocarboxylic acids. Suitable monophenols are phenol itself, alkylphenols such as cresols, p-tert-butylphenol, cumylphenol, p-n-octylphenol, p-isooctylphenol, p-n-nonylphenol and p-isononylphenol, halogeno-phenols such as p-chlorophenol, 2,4-dichlorophenol, p-bromophenol, 2,4,6-tribromophenol, 2,4,6-triiodophenol and p-iodophenol, and mixtures thereof. Preferred chain terminators are phenol, cumylphenol and/or p-tert-butylphenol.

Within the framework of the present invention, particularly preferred polycarbonates are homopolycarbonates based on bisphenol A and copolycarbonates based on monomers selected from at least one of the group comprising bisphenol A, 1,1-bis(4-hydroxyphenyl)-3,3,5-trimethylcyclohexane, 2-hydrocarbyl-3,3-bis(4-hydroxyaryl)-phthalimidines and the reaction products of N-phenylisatin and phenol. The polycarbonates can be linear or branched, in known manner. The proportion of comonomers, based on bisphenol A, is generally up to 60 wt. %, preferably up to 50 wt. % and particularly preferably 3 to 30 wt. %. It is also possible to use mixtures of homopolycarbonate and copolycarbonates.

Polycarbonates and copolycarbonates containing 2-hydrocarbyl-3,3-bis(4-hydroxy-aryl)phthalimidines as monomers are known inter alia from EP 1 582 549 A1. Polycarbonates and copolycarbonates containing bisphenol monomers based on reaction products of N-phenylisatin and phenol are described e.g. in WO 2008/037364 A1.

The thermoplastic aromatic polycarbonates have average molecular weights (weight-average M_{w}, measured by GPC (gel permeation chromatography with polycarbonate standard)) of 10,000 to 80,000 g/mol, preferably of 14,000 to 32,000 g/mol and particularly preferably of 18,000 to 32,000 g/mol. In the case of polycarbonate injection mouldings, the preferred average molecular weight is 20,000 to 29,000 g/mol. In the case of polycarbonate extrusion mouldings, the preferred average molecular weight is 25,000 to 32,000 g/mol.

The polycarbonates can also contain fillers. Suitable fillers are glass spheres, hollow glass spheres, glass flakes, carbon blacks, graphites, carbon nanotubes, quartzes, talc, micas, silicates, nitrides, wollastonite and pyrogenic or precipitated silicic acids, the latter having BET specific surface areas of at least 50 m²/g (according to DIN 66131/2).

Preferred fibrous fillers are metallic fibres, carbon fibres, plastic fibres, glass fibres or ground glass fibres, the last two being particularly preferred. Other preferred glass fibres are those used in the form of rovings, long glass fibres and chopped glass fibres made of M-, E-, A-, S-, R- or C-glass, E-, A- or C-glass being particularly preferred.

The diameter of the fibres is preferably 5 to 25 μm, particularly preferably 6 to 20 μm and very particularly preferably 7 to 15 μm. The long glass fibres have a length preferably of 5 to 50 mm, particularly preferably of 5 to 30 mm, very particularly preferably of 6 to 15 mm and especially of 7 to 12 mm; they are described e.g. in WO-A 2006/040087. The chopped glass fibres have a length of more than 60 μm, preferably in a proportion of at least 70 wt. % of the glass fibres.

Other inorganic fillers are inorganic particles whose shape is selected from the group comprising spherical/cubic, tabular/discus-like and plate-like geometries. Particularly suitable inorganic fillers are those with spherical or plate-like, preferably in finely divided and/or porous form with a large external and/or internal surface area. These are preferably thermally inert inorganic materials based especially on nitrides such as boron nitride; oxides or mixed oxides such as cerium oxide or aluminium oxide; carbides such as tungsten carbide, silicon carbide or boron carbide; powdered quartz such as quartz flour; amorphous SiO₂; ground sand; glass particles such as glass powders, especially glass spheres; silicates or aluminosilicates; and graphite, especially high-purity synthetic graphite. Quartz and talc are particularly preferred and quartz is very particularly preferred (spherical particle shape). These fillers are characterized by a mean diameter d_{50%} of 0.1 to 10 μm, preferably of 0.2 to 8.0 μm and particularly preferably of 0.5 to 5 μm.

The silicates are characterized by a mean diameter d_{50%} of 2 to 10 μm, preferably of 2.5 to 8.0 μm, particularly preferably of 3 to 5 μm and especially of 3 μm, the upper diameter d_{95%} respectively being preferably 6 to 34 μm, particularly preferably 6.5 to 25.0 μm, very particularly preferably 7 to 15 μm and especially 10 μm. The silicates have a BET specific surface area, determined by nitrogen adsorption according to ISO 9277, preferably of 0.4 to 8.0 m²/g, particularly preferably of 2 to 6 m²/g and very particularly preferably of 4.4 to 5.0 m²/g.

Particularly preferred silicates contain at most only 3 wt. % of minor constituents, preferably in the following proportions:

### Al₂O₃<2.0 wt. %,

### Fe₂O₃<005 wt. %,

### (CaO+MgO)<0.1 wt. %,

(Na₂O+K₂O)<0.1 wt. %, based in each case on the total weight of the silicate.

Another advantageous embodiment uses wollastonite or talc in the form of finely ground types with a mean particle diameter d₅₀ of <10 μm, preferably of <5 μm, particularly preferably of <2 μm and very particularly preferably of <1.5 μm. The particle size distribution is determined by air classification.

The silicates can be coated with organosilicon compounds, preferably using epoxysilane, methylsiloxane and methacrylosilane sizes. An epoxysilane size is particularly preferred.

The fillers can be added in an amount of up to 40 wt. %, based on the amount of polycarbonate. The preferred amount is 2.0 to 40.0 wt. %, preferably 3.0 to 30.0 wt. %, particularly preferably 5.0 to 20.0 wt. % and very particularly preferably 7.0 to 14.0 wt. %.

Suitable blending partners for polycarbonates are graft polymers of vinyl monomers on graft bases such as diene rubbers or acrylate rubbers. Graft polymers B are preferably made up of

B.1 5 to 95 wt. %, preferably 30 to 90 wt. %, of at least one vinyl monomer on
B.2 95 to 5 wt. %, preferably 70 to 10 wt. %, of one or more graft bases with glass transition temperatures of <10° C., preferably of <0° C. and particularly preferably of <−20° C.

Graft base B.2 generally has a mean particle size (d₅₀ value) of 0.05 to 10 μm, preferably of 0.1 to 5 μm and particularly preferably of 0.2 to 1 μm.

Monomers B.1 are preferably mixtures of

B.1.1 50 to 99 parts by weight of vinylaromatics and/or ring-substituted vinyl-aromatics (such as styrene, α-methylstyrene, p-methylstyrene, p-chlorostyrene) and/or C₁-C₈-alkyl methacrylates (such as methyl methacrylate, ethyl methacrylate), and
B.1.2 1 to 50 parts by weight of vinyl cyanides (unsaturated nitriles such as acrylonitrile and methacrylonitrile) and/or C₁-C₈-alkyl (meth)acrylates (such as methyl methacrylate, n-butyl acrylate, t-butyl acrylate) and/or derivatives (such as anhydrides and imides) of unsaturated carboxylic acids, e.g. maleic anhydride and N-phenylmaleimide.

Preferred monomers B.1.1 are selected from at least one of the monomers styrene, α-methylstyrene and methyl methacrylate; preferred monomers B.1.2 are selected from at least one of the monomers acrylonitrile, maleic anhydride and methyl methacrylate. Particularly preferred monomers are styrene for B.1.1 and acrylonitrile for B.1.2.

Examples of suitable graft bases B.2 for graft polymers B are diene rubbers, EP(D)M rubbers, i.e. rubbers based on ethylene/propylene and optionally diene, and acrylate, polyurethane, silicone, chloroprene and ethylene/vinyl acetate rubbers.

Preferred graft bases B.2 are diene rubbers based e.g. on butadiene and isoprene, or mixtures of diene rubbers, or copolymers of diene rubbers or their mixtures with other copolymerizable monomers (e.g. according to B.1.1 and B.1.2), with the proviso that the glass transition temperature of component B.2 is <10° C., preferably <0° C. and particularly preferably <−10° C. Pure polybutadiene rubber is particularly preferred.

Examples of particularly preferred polymers B are ABS polymers (emulsion, bulk and suspension ABS), e.g. those described in DE-OS 2 035 390 (=U.S. Pat. No. 3,644,574), DE-OS 2 248 242 (=GB-PS 1 409 275) or Ullmanns Encyclopaedia of Chemical Technology, Vol. 19 (1980), p. 280 et seq. The gel content of graft base B.2 is at least 30 wt. %, preferably at least 40 wt. % (measured in toluene).

Graft copolymers B are prepared by free-radical polymerization, e.g. by emulsion, suspension, solution or bulk polymerization, preferably by emulsion or bulk polymerization.

As it is known that the graft monomers are not necessarily completely grafted on to the graft base in the grafting reaction, graft polymers B are understood according to the invention as including the products resulting from (co)polymerization of the graft monomers in the presence of the graft base and obtained with graft polymers B in the work-up.

The polymer compositions can optionally also contain other conventional polymer additives, e.g. the antioxidants, heat stabilizers, mould release agents, fluorescent whiteners, UV absorbers and light scattering agents described in EP-A 0 839 623, WO-A 96/15102, EP-A 0 500 496 or “Plastics Additives Handbook”, Hans Zweifel, 5th Edition 2000, Hanser Verlag, Munich, in the amounts conventionally used for the thermoplastics in question.

Suitable UV stabilizers are benzotriazoles, triazines, benzophenones and/or arylated cyanoacrylates. Particularly suitable UV absorbers are hydroxybenzotriazoles such as 2-(3′,5′-bis(1,1-dimethylbenzyl)-2′-hydroxyphenyl)benzotriazole (Tinuvin® 234, Ciba Spezialitätenchemie, Basel), 2-(2′-hydroxy-5′-(tert-octyl)phenyl)benzotriazole (Tinuvin® 329, Ciba Spezialitätenchemie, Basel), 2-(2′-hydroxy-3′-(2-butyl)-5′-(tert-butyl)phenyl)benzotriazole (Tinuvin® 350, Ciba Spezialitätenchemie, Basel) and bis(3-(2H-benzotriazolyl)-2-hydroxy-5-tert-octyl)methane (Tinuvin® 360, Ciba Spezialitätenchemie, Basel), 2-(4,6-diphenyl-1,3,5-triazin-2-yl)-5-(hexyloxy)phenol (Tinuvin® 1577, Ciba Spezialitätenchemie, Basel), the benzophenones 2,4-dihydroxybenzophenone (Chimasorb® 22, Ciba Spezialitätenchemie, Basel) and 2-hydroxy-4-(octyloxy)benzophenone (Chimasorb® 81, Ciba, Basel), 2-propenoic acid 2-cyano-3,3-diphenyl-2,2-bis[[(2-cyano-1-oxo-3,3-diphenyl-2-propenyl)oxy]-methyl]-1,3-propanediyl ester (9CI) (Uvinul® 3030, BASF AG Ludwigshafen), 2-[2-hydroxy-4-(2-ethylhexyl)oxy]phenyl-4,6-di(4-phenyl)phenyl-1,3,5-triazine (CGX UVA 006, Ciba Spezialitätenchemie, Basel) or tetraethyl 2,2′-(1,4-phenylene-dimethylidene)bismalonate (Hostavin® B-Cap, Clariant AG).

The polymer composition can conventionally contain UV absorbers in an amount of 0 to 5 wt. %, preferably of 0.1 to 2.5 wt. %, based on the total composition.

The polymer compositions are prepared by common incorporation processes in which the individual constituents are brought together, mixed and homogenized; in particular, the homogenization preferably takes place in the melt under the action of shear forces. Optionally, the bringing together and mixing prior to the melt homogenization are effected using powdered premixes.

The substrate material can take the form of a film or sheet. The film can be deformed and back injection moulded with another thermoplastic from among those mentioned above (film insert moulding (FIM)). The sheets can be thermoformed, processed by drape forming or bent cold. Shaping can also be effected by injection moulding processes. These processes are known to those skilled in the art.

The thickness of the substrate layer must be such as to ensure sufficient rigidity of the component.

In the case of a film, substrate layer A can be reinforced by back injection moulding to ensure sufficient rigidity.

The total thickness of layer A, i.e. including possible back injection moulding, is generally 1 μm-10 mm. Particularly preferably, the thickness of layer A is 1 mm-10 mm, 1 mm-5 mm or 2 mm-4 mm. In particular, the thickness data refer to the total substrate thickness when using polycarbonate as the substrate material, including possible back injection moulding.

In the case of PET, the layer thickness is preferably 10 μm-100 μm (PET). The thickness of a PC film is preferably 100 μm-1 mm (PC film), it being possible to reinforce these thermoplastics by back injection moulding.

In the case of metallic substrates, the layer thickness is generally 300 μm-750 p.m. In the case of glass substrates, the layer thickness is generally 750 μm-3 mm, preferably 800 μm-2 mm.

### Layer B:

Layer B is selected from the metals mentioned above. It is preferably free of copper, copper-containing compounds or copper-containing alloys.

The thickness of layer B is generally 40 nm-250 nm, preferably 55 nm-200 nm and especially 80 nm-130 nm.

The particularly preferred layer thickness when using titanium is in the range 105 nm-120 nm.

### Layer C:

The thickness of layer C is generally 80 nm-250 nm, preferably 90 nm-160 nm and particularly preferably 100 nm-130 nm.

In the case of silver, high-purity silver is used. Commercially available products are obtainable from Heraeus Precious Metals (e.g.: Ag target, purity 3N7) or Umicore.

### Layer D:

The thickness of layer D is generally 80 nm-250 nm, preferably 90 nm-160 nm n, particularly preferably 90 nm-130 nm and very particularly preferably 90 nm-110 nm.

### Layer E:

The thickness of layer E is generally 1 nm-200 nm, preferably 10 nm-150 nm, particularly preferably 20 nm-100 nm and very particularly preferably 30 nm-50 nm.

### Application of the Layers:

Layers B and C are both applied by vapour deposition or sputtering.

Layer D is applied by reactive vapour deposition or reactive sputtering with oxygen as the reactive gas. These processes are generally known and are described e.g. in Vakuumbeschichtung, Volumes 1-5, Ed. Hartmut Frey, VDI Verlag, 1995.

Metals can be applied to the polymer by a variety of methods, e.g. vapour deposition or sputtering. The processes are described in greater detail e.g. in “Vakuumbeschichtung Vol. 1 to 5”, H. Frey, VDI-Verlag Düsseldorf 1995, or “Oberflächen-und Dünnschicht-Technologie” Part 1, R. A. Haefer, Springer Verlag 1987.

To achieve better metal adhesion and clean the substrate surface, the substrates are normally subjected to a plasma pretreatment. A plasma pretreatment may alter the surface properties of polymers. These methods are described e.g. by Friedrich et al. in Metallized Plastics 5 & 6: Fundamental and applied aspects, and by H. Grünwald et al. in Surface and Coatings Technology 111 (1999) 287-296.

Layer E is applied by a PECVD (plasma enhanced chemical vapour deposition) or plasma polymerization process, where low-boiling precursors based principally on siloxane are vaporized into a plasma and thereby activated so that they can form a film. The process is described inter alia in Surface and Coatings Technology 111 (1999) 287-296.

Other functional layers, e.g. layers for counteracting mechanical stress and/or reflection-enhancing layers, based on highly refractive metal oxides (e.g. TiO₂), can be applied. Such layers are described e.g. in WO 2010/127805 and WO 2010/085909.

The multilayer assembly according to the invention can be used as a reflector for photovoltaic panels (concentrating photovoltaics), solar panels (concentrating solar power) and lighting systems, as a mirror in residential environments and in the vehicle sector (e.g. aircraft and railway vehicles, buses, utility vehicles and automobiles) and as a reflector in light guide systems. The present invention therefore also provides photovoltaic panels, solar panels and lighting systems containing a multilayer assembly according to the invention.

The invention is illustrated in greater detail by the Examples which follow, without implying a limitation. The Examples according to the invention only represent preferred embodiments of the present invention.

### EXAMPLES

### Production of Layer A

Sheet (105×150×3.2 mm) of polycarbonate based on bisphenol A:

PC-1: Makrolon® 2407, Bayer MaterialScience AG, Leverkusen, Germany, with a melt volume rate (MVR) of 19 cm³/10 min, measured according to ISO 1133 at 300 and 1.2 kg.
PC-2: Makrolon® 2808, Bayer MaterialScience AG, Leverkusen, Germany, with a melt volume rate (MVR) of 9 cm³/10 min, measured according to ISO 1133 at 300 and 1.2 kg.

### Production of the Sheet:

Rectangular injection-moulded sheets of dimensions 150×105×3.2 mm, with side gate, were made. The stock temperature was 300-330° C. and the mould temperature was 100° C. Prior to processing, the appropriate granules were dried for 5 hours in a vacuum drying cabinet at 120° C.

### Determination of the Roughness of Layer A

Because of the concentrating optics, the efficiency of the entire system is greatly dependent on scattered light. A prerequisite for minimizing the scattered light that occurs is smooth substrate surfaces. The roughness of the surfaces modelled in the injection mould was determined. The Rₐ (average roughness) was used as a measure of the roughness. The following methods were used to measure the values on uncoated sheets, using measurement fields of different sizes, so as to be able to establish the roughness over larger areas:
AFM (atomic force microscopy):
   Size of measurement field examined: 5 μm×5 μm
   Size of measurement field examined: 20 μm×20 μm
WLI (white light interferometry):
   Size of measurement field examined: 100 μm×100 μm

| Material | Colour | AFM | | WLI |
|---|---|---|---|---|
| Measure- | | 5 μm × 5 μm | 20 μm × 20 μm | 100 μm × 100 μm |
| ment field | | | | |
| PC-1 | black | 1.2 nm | 3.0 nm | 4.11 nm |
| PC-1 | trans- | 1.6 nm | 3.4 nm | 4.27 nm |
| | parent | | | |

The roughness Rₐ is below 5 nm, so the surfaces present are very smooth.

### Layer B:

The following metals were used as layer B:

titanium (according to the invention) or copper and aluminium (both Comparison Examples).

Experiments were performed in order to determine the suitability of particular metals for the production of layer B. The multilayer assemblies described in Table 1 below were produced analogously to the description for Example 1.

TABLE 1

| | Sample A | | Sample B | | Sample C | |
|---|---|---|---|---|---|---|
| Layer E/ | HMDSO 40 | nm | HMDSO 40 | nm | HMDSO 40 | nm |
| thickness | | | | | | |
| Layer C/ | Ag 110 | nm | Ag 110 | nm | Ag 110 | nm |
| thickness | | | | | | |
| Layer B/ | Al 60 | nm | Ti 100 | nm | Cu 160 | nm |
| thickness | | | | | | |

| | | | |
|---|---|---|---|
| Layer A/ | PC-2 | PC-2 | PC-2 |
| thickness | | | |

To assess the corrosion resistance, the samples were stored for 10 days at 45° C. and 100% relative humidity and then evaluated visually.

### Results:

Sample A: silver layer became whitish and peeled off in places
Sample B: no visible defects
Sample C: silver layer changed colour to golden, interdiffusion of silver and copper

The evaluation shows that copper is unsuitable as a material for layer B because of the surprisingly poor corrosion resistance. Therefore, no further experiments were carried out within the framework of the present invention on multilayer systems containing copper.

### Example 1

### Multilayer Assembly

### According to the Invention

The PC sheet (PC-1) was coated as described below. The following layer assembly was produced:

3.2 mm substrate\\110 nm Ti\\120 nm Ag\\100 nm AlOₓ\\40 nm HMDSO

### Production Process:

1. The PC sheet was transferred to the vacuum chamber, which was evacuated down to p<2·10⁻⁵ mbar.
2. Plasma pretreatment: The PC sheet was pretreated for 1 min at 500 W and 0.1 mbar Ar in medium frequency plasma (40 kHz).
3. Layer B: The titanium layer was deposited by DC sputtering. The coating source used was an ION′X-8″HV round planar magnetron from Thin Film Consulting, with a diameter of 200 mm, which was operated by a “Pinnacle™ Plus+5 kW” generator from Advanced Energy. Firstly, the target (here: titanium) was presputtered for 1 min with the shutter closed, and then the titanium layer was deposited on the PC sheet over 3 min 40 s at 2000 W and a pressure of p=5·10⁻³ mbar with the shutter open.
4. Layer C: The silver layer was deposited by DC sputtering. The coating source used was an ION′X-8″HV round planar magnetron from Thin Film Consulting, with a diameter of 200 mm, which was operated by a “Pinnacle™ Plus+5 kW” generator from Advanced Energy. Firstly, the target (here: silver) was presputtered for 1 min with the shutter closed, and then the silver layer was deposited on the titanium layer over 51 s at 2000 W and a pressure of p=5·10⁻³ mbar with the shutter open.

The coated PC sheet was then removed from the coating unit and the latter was prepared for the final layers.
5. The coated PC sheet was returned to the vacuum chamber, which was evacuated down to p<2·10⁻⁵ mbar.
6. Plasma pretreatment: The coated PC sheet was pretreated for 1 min at 500 W and 0.1 mbar Ar in medium frequency plasma (40 kHz).
7. Layer D: The AlOₓ layer was deposited by pulsed DC reactive sputtering at a pulse frequency of 150 kHz. The coating source used was an ION′X-8″HV round planar magnetron from Thin Film Consulting, with a diameter of 200 mm, which was operated by a “Pinnacle™ Plus+5 kW” generator from Advanced Energy. Firstly, the target (here: aluminium) was presputtered for 1 min with the shutter closed, and then the AlOₓ layer was deposited on the silver layer over 4 min at 340 V in voltage regulation mode and at a total pressure of p=5·10⁻³ mbar with the shutter open. The O₂/Ar ratio was adjusted to 8%.
8. Layer E: HMDSO (hexamethyldisiloxane) was applied to the AlOₓ layer as a further protective layer by plasma polymerization. The layer was applied over 35 s at an initial pressure of p=0.038 mbar, a flow rate of 90 sscm HMDSO and a medium frequency power (40 kHz) of 1500 W. The source used was a parallel reactor unit with a plate gap of approx. 200 mm, the plate being located in the middle. The source was operated by an Advanced Energy PEII (5 kW), incl. LMII high voltage transformer.

Throughout all the coating steps the plate was rotated over the coating sources at approx. 20 rpm in order to increase the homogeneity of the coating.

### Example 2

### Comparative Example without HMDSO

The PC sheet (PC-1) was coated with the following layer assembly analogously to Example 1, except that no HDMSO coating was applied:

3.2 mm substrate\\110 nm Ti\\120 nm Ag\\100 nm AlOₓ
Throughout all the coating steps the samples/plate were rotated over the sources at approx. 20 rpm in order to increase the homogeneity of the coating.

### Example 3

### Comparative Example

Silver was replaced with aluminium in layer C.

The PC sheet (PC-1) is coated as follows:

3.2 mm substrate\\approx. 100 nm Al\\approx. 40 nm HMDSO

### Production Process:

1. The PC sheet was transferred to the vacuum chamber, which was evacuated down to p<2·10⁻⁵ mbar.
2. Plasma pretreatment: The PC sheet was pretreated for 1 min at 500 W and 0.1 mbar Ar in medium frequency plasma (40 kHz).
3. Layer C: The aluminium layer was deposited by DC sputtering. The coating source used was an ION′X-8″HV round planar magnetron from Thin Film Consulting, with a diameter of 200 mm, which was operated by a “Pinnacle™ Plus+5 kW” generator from Advanced Energy. Firstly, the target (here: aluminium) was presputtered for 2 min with the shutter closed, and then the Al layer was deposited over 150 s at 2000 W and a pressure of p=5·10⁻³ mbar with the shutter open.
4. Layer E: HMDSO (hexamethyldisiloxane) was applied to the Al layer as a protective layer by plasma polymerization. The layer was applied over 35 s at an initial pressure of p=0.038 mbar, a flow rate of 90 sscm HMDSO and a medium frequency power (40 kHz) of 1500 W. The source used was a parallel reactor unit with a plate gap of approx. 200 mm, the sample/plate being located in the middle. The coating source was operated by an Advanced Energy PEII (5 kW), incl. LMII high voltage transformer.

Throughout all the coating steps the samples/plate were rotated over the coating sources at approx. 20 rpm in order to increase the homogeneity of the coating.

### Adjustment of the Layer Thicknesses:

The layer thicknesses were adjusted by firstly calibrating the process parameters. This was done by depositing different layer thicknesses with defined process parameters on to a microscope slide which was provided with adhesive tape in the middle to create a step. After deposition of the appropriate layer, the adhesive tape was removed and the height of the step formed was determined with a KLA-Tencor Alpha-Step 500 Surface Profiler from Tencor Instruments.

This enables process parameters to be determined, which have to be adjusted for the production of the desired target layer thickness.

### Measurement of the Layer Thickness on the Finished Part:

The layer thickness can be determined on the finished part by TOF-SIMS (time of flight-secondary ion mass spectrometry) or by XPS (X-ray photospectroscopy) in combination with TEM (transmission electron microscopy).

### Weathering Results:

TABLE 2
Test and evaluation methods:

| Test | Conditions | Time (h) | Assessment |
|---|---|---|---|
| Climate | 100 cycles from −40° C. to | approx, | determi- |
| change test | 110° C. (14 cycles per day), | 650 h | nation of RI |
| (DIN EN | followed by 20 cycles of | | |
| 62108 10.6 | humidity freeze test (20 h at | | |
| & 10.8) | 85° C./85% relative humidity, | | |
| | followed by 4 h of cooling to | | |
| | −40° C. and then reheating to | | |
| | 85° C./85% relative humidity) | | |
| Xenon test | 0.75 W/m²/nm at 340 nm, | 1000 h | determi- |
| | boro-boro filter, black panel | | nation of RI |
| | temperature 70° C., 50% | | |
| | relative humidity, without | | |
| | rain | | |
| Damp heat | 85° C., 85% relative humidity | 1000 h | determi- |
| test | | | nation of RI |
| (DIN EN | | | |
| 62108 10.7) | | | |
| Dry heat | in circulating-air drying | 1000 h | determi- |
| test | cabinet at 125° C. | | nation of RI |

### Determination of RI (Reflection Index):

1. Determination of total reflectance (Rₜₒₜₐₗ) and diffuse reflectance (R_{diffuse}) with a Perkin Elmer Lambda 900 photospectrometer calibrated against a Spectralon standard in the range λ=200-1100 nm
2. Calculation of the direct reflection: R_{direct}=Rₜₒₜₐₗ−R_{diffuse}
3. Calculation of

$${RI}_{i} = \frac{1}{Norm} {\sum }_{i} {R}_{direct} ( λ ) \cdot {EQE}_{i} ( λ ) \cdot SP ( λ )$$

$$where i = 1 , 2 , 3$$

4. Whereby RI=min (RIᵢ) when i=1, 2
   EQEᵢ(λ) (external quantum efficiency)=e.g. Spectrolab CIMJ
   SP(λ)=solar spectrum according to ASTM G173-03

TABLE 3
The following samples were weathered:

| | Example 1 | | | | | |
|---|---|---|---|---|---|---|
| | (according to | | Example 2 | | Example 3 | |
| Layer | the invention) | | (Comparison) | | (Comparison) | |
| Layer E | 40 | nm HMDSO | | | 40 | nm HMDSO |
| Layer D | 100 | nm AlOₓ | 100 | nm AlOₓ | | |
| Layer C | 120 | nm Ag | 120 | nm Ag | 100 | nm Al |
| Layer B | 110 | nm Ti | 110 | nm Ti | | |

| | | | |
|---|---|---|---|
| Layer A | PC-1 | PC-1 | PC-1 |

TABLE 4
Direct reflectance and RI - initial values:

| R_{direct} | RI | 400 nm | 500 nm | 700 nm | 900 nm |
|---|---|---|---|---|---|
| Ex. 1 | 95.9% | 88.0% | 96.6% | 96.2% | 95.7% |
| Ex. 2 | 92.7% | 84.0% | 93.2% | 93.9% | 95.1% |
| Ex. 3 | 83.4% | 79.5% | 83.2% | 83.8% | 86.6% |

TABLE 5
RI after weathering:

| | Climate change | Xenon test | Damp heat | Dry hot |
|---|---|---|---|---|
| RI | test | (after 1000 h!) | test | test |
| Ex. 1 | 95.1% | 95.0% | 95.6% | 96.8% |
| Ex. 2 | 89.0% | 92.1% | 60.0% | 94.0% |
| Ex. 3 | 1% | 82.3% | 0.0% | 84.6% |

The layers of Examples 2 and 3 (Comparison) exhibit unsatisfactory weathering behaviour, whereas the layers of Example 1 (according to the invention) meet the requirements to satisfy the requisite demand for durability of high reflectivity.

1. Multilayer assembly containing five layers:
layer A: a substrate layer selected from a thermoplastic, metal and glass;
layer B: a barrier layer selected from titanium and the precious metal group, preferred precious metals being gold, palladium, platinum, vanadium and tantalum;
layer C: a reflective metallic layer;
layer D: an oxidic layer selected from aluminium oxide (AlOₓ), titanium dioxide, SiO₂, Ta₂Os, ZrO₂, Nb₂O₅ and HfO;
layer E:
a) a plasma polymer layer (anticorrosive layer) deposited from siloxane precursors selected from hexamethyldisiloxane (HMDSO), octamethylcyclotetrasiloxane (OMCTS), octamethyltrisiloxane (OMTS), tetraethylorthosilane (TEOS) and tetramethyldisiloxane (TMDSO), decamethylcyclopentasiloxane (DMDMS), hexamethylcyclotrisiloxane (HMCTS), trimethoxymethylsilane (TMOMS) and tetramethylcyclotetrasiloxane (TMCTS); alternatively, in the case where layer D consists of aluminium oxide or SiO₂, layer E can be
b) a highly refractive metal oxide layer, the metal oxides being selected from titanium dioxide, Ta₂Os, ZrO₂, Nb₂O₅ and HfO, and another layer as defined in layer E (a), i.e. a plasma polymer layer, can optionally be applied.

2. Multilayer assembly according to claim 1 wherein the thermoplastic is selected from at least one of the group comprising polycarbonate, polystyrene, styrene copolymers, aromatic polyesters, cyclic polyolefins, poly- or copolyacrylates and poly- or copolymethacrylates, copolymers with styrene, thermoplastic polyurethanes, polymers based on cyclic olefins, and polycarbonate blends with olefinic copolymers or graft polymers, e.g. styrene/acrylonitrile copolymers.

3. Multilayer assembly according to claim 1 wherein layer B consists of titanium.

4. Multilayer assembly according to claim 1 wherein layer C consists of silver or silver alloys, the silver alloy containing less than 10 wt. % of gold, platinum, palladium and/or titanium, and aluminium.

5. Multilayer assembly according to claim 4 wherein layer C consists of silver.

6. Multilayer assembly according to claim 1 wherein layer D consists of aluminium oxide (AlOₓ) or titanium dioxide.

7. Multilayer assembly according to claim 1 wherein layer E is hexamethyl-disiloxane.

8. Multilayer assembly according to claim 1 wherein the thicknesses of the layers is as follows:
total thickness of layer A: 1 μm-10 mm in the case of thermoplastics, 300 μm-750 μm in the case of metallic substrates, 750 μm-3 mm in the case of glass,
layer B: 40 nm-250 nm,
layer C: 80 nm-250 nm,
layer D: 80 nm-250 nm,
layer E: 1 nm-200 nm.

9. Multilayer assembly according to claim 1 wherein layer A has a total thickness of 1 mm to 5 mm.

10. Multilayer assembly according to claim 1 wherein the thickness of layer B is 80 to 130 nm.

11. Multilayer assembly according to claim 1 wherein layer B consists of titanium and is a thickness of 105 nm to 120 nm.

12. Multilayer assembly according to claim 1 wherein the thickness of layer C is 90 nm to 160 nm, that of layer D) is 90 nm to 160 nm and that of layer E is 20 nm to 100 nm.

13. Multilayer assembly according to claim 1 wherein the thermoplastic is selected from the group comprising polycarbonate, aromatic polyesters and polycarbonate blends, it being possible for these thermoplastics to contain fillers.

14. Use of the multilayer assembly according to claim 1 as a reflector in photovoltaic panels, solar panels and lighting systems, as a mirror in residential environments and in the vehicle sector, and as a reflector in light guide systems.

15. Photovoltaic panels, solar panels, lighting systems and light guide systems containing a multilayer assembly according to claim 1.

16. Mirror containing a multilayer assembly according to claim 1.
